(19) United States
(12) Patent Application Publication
(10) Pub. No.: US 2025/0203712 A1
(43) Pub. Date: Jun. 19, 2025

(54) Methods and Devices for Session Release

(71) Applicant: Telefonaktiebolaget LM Ericsson (publ), Stockholm (SE)

(72) Inventors: Jie Ling, Shanghai (CN); Juying Gan, Shanghai (CN); Paul Schliwa-Bertling, Ljungsbro (SE); Alexander Vesely, Feldbach (AT); Shabnam Sultana, Montreal (CA)

(21) Appl. No.: 18/552,459

(22) PCT Filed: May 10, 2022
(86) PCT No.: PCT/CN2022/091888

§ 371 Date: Sep. 26, 2023

(30) Foreign Application Priority Data
May 10, 2021 (WO) PCT/CN2021/092915

(51) Int. Cl. H04W 76/30; H04W 72/30; H04W 76/40

(52) U.S. Cl. CPC H04W 76/30; H04W 72/30; H04W 76/40

(57) ABSTRACT

A method implemented by a first network node is provided. The method comprises: receiving a first multicast session release request from a second network node including an identifier of a multicast broadcast service, MBS, session; selecting terminal devices having joined the MBS session from terminal devices served by the first network node; and transmitting a first multicast session release response to the second network node. The present disclosure may enable NG-RAN to release radio resources at the first time when AF decides to release the multicast session so that the radio resources can be utilized in an efficient way.

### TECHNICAL FIELD

The present disclosure generally relates to the field of session release, and more particularly to methods and devices for multicast broadcast service (MBS) session release.

### BACKGROUND

This section introduces aspects that may facilitate better understanding of the present disclosure. Accordingly, the statements of this section are to be read in this light and are not to be understood as admissions about what is in the prior art or what is not in the prior art.

3GPP (3^{rd} Generation Partner Project) has earlier developed the MBMS (Multicast/Broadcast Multimedia Subsystem, see 3GPP TS 23.246 v16.1.0) for 3G networks for video multicast/broadcasting and streaming services and later introduced the eMBMS (evolved MBMS) for EPS (Evolved Packet System). In Rel-13 and Rel-14, the MBMS system has been updated to support new services such as Public Safety, CIoT (Cognitive Internet of Things) and V2X (Vehicle to Everything).

The scope of a new Release-17 study in the 3GPP SA2 working group is to study both multicast requirements and use cases for CIoT, Public Safety, V2X etc., as well as dedicated broadcasting requirements and use cases. The study targets the 5G Release 17 and the New Radio (NR) radio access. The study results so far have been documented in the TR 23.757 V1.3.0 and the normative work has been document TS 23.247 V0.2.0.

In TS 23.247, the MBS session release procedure is described in clause 7.1.1.2.

### Removal of MBS Session Configuration

The removal of configuration steps for the MBS Session is used by the AF (Application Function) to stop the MBS Session towards 5GC (5^{th} Generation Core) and consists of TMGI (Temporary Mobile Group Identity) de-allocation and session stop procedures, and they apply to both multicast and broadcast communications unless otherwise stated. The MBS session release/deactivation procedure may follow removal of the MBS session configuration to release the reserved resources towards NG-RAN (Next Generation-Radio Access Network). FIG. 1 illustrates removal of configuration for MBS Session.

At step 1, AF of content provider may request stop contents for the MBS session (MBS Session ID) to NEF (Network Exposure Function).

At step 2, NEF/MBSF (Multicast Broadcast Service Function) requests MB-SMF (Multicast Broadcast-Session Management Function) to release ingress resources for the MBS distribution session.

At steps 3 and 4, MB-SMF requests the MB-UPF to release user plane ingress resources.

At an optional step 5, MB-SMF sends MBS Policy Association Termination Request to PCF (Policy Control Function).

At an optional step 6, PCF de-registers at the BSF (Binding Support Function) that it handles the multicast session.

At an optional step 7, PCF responds with MBS Policy Association Termination Response.

At a conditional step 8, if MB-SMF configured the profile with an MBS session ID when the MBS session was configured, MB-SMF updates its NF (Network Function) profile at NRF (NF Repository Function) to release the MBS Session ID.

At step 9, MB-SMF responds to the NEF/MBSF.

At step 10, NEF/MBSF responds to the AF.

At optional steps 11 and 12, AF requests NEF/MBSF to de-allocate TMGI(s), and NEF/MBSF forwards the request to MB-SMF.

It should be noted that depending on the configuration, MB-SMF may receive requests from AF directly, or via NEF, or via MBSF, or via NEF and MBSF.

At steps 13 and 14, MB-SMF responds to NEF or MBSF and to AF by sending a de-allocate TMGI Response message.

In TS 23.247, the UE (User Equipment) session leave procedure is described in clause 7.2.2.2.

### MBS Session Leave

When the UE determines to leave the Multicast MBS Service, it shall send a PDU session Modification request to inform the 5GC of the leaving operation. FIG. 2 illustrates UE initiated multicast MBS session leave.

At step 1, the UE sends the PDU Session Modification Request when the UE determines to leave the Multicast MBS Service. The Request carries the MBS session ID which the UE wants to leave.

At step 2, The AMF (Access and Mobility Management Function) invokes Nsmf_PDUSession_UpdateSMContext to SMF, including MBS session leaving information (i.e. leave indication, MBS session ID, etc.).

At a conditional step 3, if the UE is the last UE served with 5GC Individual MBS traffic delivery method in this SMF for this MBS session and the SMF is not collocated with the MB-SMF, the SMF configures the UPF (User Plane Function) to stop receiving multicast data from the MB-UPF and invokes Nsmf_MBSession_Update Request (MBS session ID) to release the tunnel between UPF and MB-UPF for this MBS session.

At a conditional step 4, if the tunnel between the UPF and the MB-SMF shall be released, the MB-SMF requests to the MB-UPF to release the tunnel.

At a conditional step 5, the MB-SMF responds to the SMF for step 3.

At step 6, the SMF responds (PDU Session ID, N2 SM information, N1 SM container). In the N2 SM information, the SMF informs the NG-RAN to remove the UE from this MBS session if 5GC Shared MBS traffic delivery method is used.

In the N2 SM information, the SMF also informs the NG-RAN to release the QoS (Quality of Service) flow which carries or intends to carry the Multicast MBS traffic as defined in TS 23.502 clause 4.3.3.2.

At step 7, the AMF sends N2 message (N2 SM information, N1 SM container) to the NG-RAN.

At step 8, the NG-RAN performs the necessary AN-specific resource modification procedure towards the UE and transports the N1 SM container received in step 7 to the UE.

At step 9, the NG-RAN removes the UE from this MBS session and sends a N2 message to the AMF.

At step 10, the AMF transfers the N2 message received in step 9 to the SMF via the Nsmf_PDUSession_UpdateSMContext service operation. The SMF removes the UE from the MBS Session.

At step 11, if the UE is the last UE in this RAN node for this MBS session, the NG-RAN releases the MBS session between the NG-RAN and the MB-UPF.

To enable the session deactivation to be handled in a per MBS session manner, a solution for enabling NG-RAN to register and de-register towards MB-SMF is further introduced, as well as the deactivation from MB-SMF to NG-RAN.

### Establishment of Shared Delivery Towards RAN Node

FIG. 3 illustrates establishment of shared delivery towards a RAN node.

At step 1, a RAN node discovers that it needs to establish shared delivery for an MBS session because it serves at least one UE within the MBS session. This may occur after the UE joined the MBS session or as the result of a handover of the UE. For location dependent services, the RAN node needs to establish shared delivery for the location dependent contents of an MBS session if it serves at least one UE assigned to an MBS session ID and an area session ID.

At step 2, the RAN node sends a multicast distribution request to the AMF and provides the TMGI as an MBS session ID. If the RAN node is configured to use unicast transport for the shared delivery, it allocates a GTP (GPRS (General Packet Radio Service) Tunnelling Protocol) tunnel endpoint and provides that endpoint. For location dependent services, the RAN node also provides the area session ID.

At step 3, the AMF discovers the MB-SMF serving the multicast session using the NRF discovery service. It sends a Multicast distribution request to the MB-SMF, passing the parameters received in message 2. The AMF adds the ID of the RAN node.

At step 4, if the MB-SMF received a GTP tunnel endpoint in message 3, it configures the MB-UPF to send multicast data for the multicast session (or location dependent content of the multicast session if an area session ID was received) towards that GTP tunnel endpoint via unicast transport.

At step 5, the MB-SMF stores the AMF and RAN node ID in the context of the multicast session (or location dependent part of the multicast session if an area session ID was received) to enable subsequent signaling towards that RAN node.

At step 6, the MB-SMF sends a multicast distribution response to the AMF. If it did not receive a GTP tunnel endpoint in message 3, it provides a GTP tunnel endpoint for multicast transport of the shared delivery.

At step 7, the AMF forwards the multicast distribution response to the RAN node. If the RAN node received a GTP tunnel endpoint for multicast transport of the shared delivery, it uses that information to join the multicast transport.

### Release of Shared Delivery Towards RAN Node

FIG. 4 illustrates release of shared delivery towards a RAN node.

At step 1, a RAN node discovers that it needs to release shared delivery for an MBS session, e.g., because it no longer serves at least one UE within the MBS session. This may occur after the UE left the MBS session or as the result of a handover of UEs. For location dependent services, the RAN node may release shared delivery for the location dependent contents of an MBS session if it no longer serves at least one UE assigned to an MBS session ID and an area session ID.

At step 2, the RAN node sends a multicast distribution release request to the AMF and provides the TMGI as the MBS session ID. For location dependent services, the RAN node also provides the area session ID.

At step 3, the AMF discovers the MB-SMF serving the multicast session using the NRF discovery service. It sends a Multicast distribution release request to the MB-SMF, passing the parameters received in message 2.

At step 4, if unicast transport was used towards the RAN node, the MB-SMF configures the MB-UPF to terminate sending multicast data for the multicast session (or location dependent content of the multicast session if an area session ID was received) towards that RAN node.

At step 5, the MB-SMF removes the RAN node ID from storage in the context of the multicast session (or location dependent part of the multicast session if an area session ID was received).

At step 6, the MB-SMF sends a multicast distribution release response to the AMF.

At step 7, the AMF forwards the multicast distribution release response to the RAN node. If the RAN node previously received a GTP tunnel endpoint for multicast transport of the shared delivery, it uses that information to leave the multicast transport. It releases local resources to receive the multicast data.

### Multicast Session Deactivation

FIG. 5 illustrates multicast session deactivation.

At step 1, the MB-SMF decides to deactivate the MBS session (or location dependent part of the multicast session), either based on a request from the NEF/MBSF and AF, or because the MB-UPF reports that it did not receive any data for the multicast session for a configured period.

At step 2, for each AMF the MB-SMF stored in the multicast context session (or location dependent part of the multicast session), it sends a multicast session deactivation request towards the AMF. The MB-SMF includes the RAN node IDs of RAN nodes that previously registered via the AMF for shared delivery. The MB-SMF also provides the MBS session ID and for location dependent services the area session ID.

It should be noted that if AMF stores the information for the RAN nodes (e.g., RAN id), MB-SMF may not have the information of RAN node IDs and only provide MBS Session ID in this step.

At step 3, for each RAN node indicated in message 2, the AMF sends a multicast session deactivation request. The AMF includes the MBS session ID and possible area session ID received in message 2. The RAN node handles the inactivation as defined in RAN specifications. UEs that have joined that multicast session can become IDLE. The N3 tunnel for 5GC Shared MBS delivery method shall not be released as long as the RAN node serves CM CONNECTED UEs within the multicast session.

In TS 23.247, MBS join and session establishment procedure is described in clause 7.2.1.3.

### MBS Join and Session Establishment Procedure

The following steps are executed before the UE requests to join the MBS session:
The MBS Session has been configured.
The UE registers in the PLMN (Public Land Mobile Network) and establishes a PDU (Protocol Data Unit) session.
The UE has known at least the MBS Session ID of a multicast group that the UE can join, e.g. via announcement.

FIG. 6 illustrates PDU Session modification for multicast.

At step 1, in order to join the multicast group, the UE sends the PDU Session Modification Request (MBS Session ID). MBS Session ID indicates the multicast group that UE wants to join.

At step 2, per the received MBS Session ID, the SMF recognizes that this is MBS Session join request. The SMF authorizes MBS Session join request, see clause 6.1.1.

At step 3, if SMF has no information about the multicast context for the indicated MBS Session, SMF checks at the NRF whether a multicast context for the indicated MBS Session exists in the system, by using Nnrf_NFDiscovery request (MBS Session ID). If a multicast context already exists in the NRF, the NRF responses with Nnrf_NFDiscovery response (MB-SMF ID).

At step 4, by using Nsmf_MBSSession_Create request (MBS Session ID), SMF interacts with MB SMF to retrieve multicast QoS flow information of the indicated MBS session.

At step 5, SMF responds to AMF through Nsmf_PDUSession_UpdateSMContext response(N2 SM information (PDU Session ID, MBS Session ID, MB-SMF ID, multicast QoS flow information, updated PDU Session information, mapping between unicast QoS flow and multicast QoS flow information), N1 SM container (PDU Session Modification Command) to:
create an MBS session context for the indicated MBS session in the RAN, if it does not exist already; and
inform about the relation including the mapping information between the multicast context and the UE's PDU session to RAN.

Based on operator policy, the SMF may prepare for individual delivery fall-back. The SMF maps the received QoS information of the multicast QoS Flow into PDU Session's QoS Flow information, and includes the information of the QoS Flows and the mapping information about the QoS Flows in the SM information sent to RAN.

At step 6, the N2 message, which includes the PDU session modification command information, is sent to the RAN.

If the MBS is not supported by NG-RAN, 5GC individual MBS traffic delivery may be used. Otherwise, 5GC shared MBS traffic delivery is adopted.

The NG-RAN uses the MBS Session ID to determine that the PDU Session Modification procedures correspond to the indicated multicast session.

If the multicast QoS information is received, the associated unicast QoS flow information is not used to allocate the radio resource.

It should be noted that it is NG-RAN that decides whether the radio resource is allocated or not.

When the NG-RAN receives an MBS Session ID but MBS Session context does not exist for that MBS Session ID, the NG-RAN uses the included MBS Session QoS information to allocate resources to serve this multicast session. Otherwise, the indicated MBS Session has been established before. The NG-RAN can use those allocated resources for MBS Session data packet transferring to UE.

At step 7, RAN, AMF, SMF, and MB-SMF perform resource reservation for individual delivery and shared delivery. SMF obtains the 5MBS capability of target NG-RAN via the accepted QFI information and determines the delivery mode between 5GC and RAN.

### SUMMARY

The present disclosure proposes a procedure of SMF removing joined UEs from MBS Session, which is part of removal of the MBS session configuration procedure.

Based on the procedure of SMF removing joined UEs from MBS Session, the present disclosure further proposes several optimizations to enable NG-RAN to release radio resources as early as possible:
Introduce an indication of MBS session release in N2 SM information for the PDU session modification command to NG-RAN so that the NG-RAN can release the radio resources immediately.
Reuse MBS Session Deactivation Request or introduce MBS Session Release Request. Depending on the decided solutions, there are several possibilities:
   MB-SMF triggers radio resource release: If NG-RAN previously performed registration towards MB-SMF (or NG-RAN performed registration towards AMF and AMF performed registration towards MB-SMF), MB-SMF can send multicast session deactivation/release request to NG-RANs via AMFs.
   AMF triggers radio resource release: If AMF is involved in the session management for shared delivery, the SMF informs the AMF the MBS session release, and then AMF can inform NG-RAN via session deactivation/release request.
   SMF triggers radio resource release: If AMF is not involved in the session management for shared delivery, SMF needs to include UE list in the session deactivation/release request towards AMF. Based on the UE list, AMF can identify the involved NG-RAN and send session deactivation/release request to NG-RANs.

According to a first aspect of the present disclosure, a method implemented by a first network node is provided. The method comprises: receiving a first multicast session release request from a second network node including an identifier of a multicast broadcast service, MBS, session; selecting terminal devices having joined the MBS session from terminal devices served by the first network node; and transmitting a first multicast session release response to the second network node.

In an alternative embodiment of the first aspect, the method may further comprise: transmitting a communication message to a third network node including a N1 session management container which indicates release of the MBS session and N2 session management information which is to inform a fourth network node of removal of a predetermined terminal device of the selected terminal devices, which is associated with the fourth network node, from the MBS session.

In a further alternative embodiment of the first aspect, the N2 session management information may include a session stop for the fourth network node to release radio resources of the MBS session.

In another further alternative embodiment of the first aspect, in the case that the third network node is not aware of involved fourth network nodes, in parallel to or prior to the transmission of the communication message, the method may further comprise:
transmitting a second multicast session deactivation or release request to the third network node including the identifier of the MBS session and a list of identifiers of the selected terminal devices; and
receiving a second multicast session deactivation or release response from the third network node.

According to a second aspect of the present disclosure, a method implemented by a second network node is provided. The method comprises: transmitting a first multicast session release request including an identifier of a multicast broadcast service, MBS, session to each of one or more first network nodes which serves terminal devices having joined the MBS session; and receiving a first multicast session release response from the first network node.

According to a third aspect of the present disclosure, a method implemented by a third network node is provided. The method comprises: receiving a communication message from a first network node including N2 session management information which is to inform a fourth network node of removal of a predetermined terminal device from a multicast broadcast service, MBS, session; and transmitting the N2 session management information to the fourth network node.

According to a fourth aspect of the present disclosure, a method implemented by a fourth network node is provided. The method comprises: receiving, from a third network node, a request including N2 session management information which indicates removal of a predetermined terminal device from a multicast broadcast service, MBS, session due to a session stop; and transmitting a Protocol Data Unit session modification command to the predetermined terminal device indicating that the predetermined terminal device is to be removed.

According to a fifth aspect of the present disclosure, a method implemented by a terminal device is provided. The method comprises: receiving a Protocol Data Unit session modification command from a fourth network node indicating that the terminal device is to be removed from a multicast broadcast service, MBS, session due to a session stop.

According to a sixth aspect of the present disclosure, a first network node is provided. The first network node comprises a processor and a memory communicatively coupled to the processor. The memory is adapted to store instructions which, when executed by the processor, cause the first network node to perform operations of the method of the above first aspect.

According to a seventh aspect of the present disclosure, a first network node is provided. The first network node is adapted to perform the method of the above first aspect.

According to an eighth aspect of the present disclosure, a second network node is provided. The second network node comprises a processor and a memory communicatively coupled to the processor. The memory is adapted to store instructions which, when executed by the processor, cause the second network node to perform operations of the method of the above second aspect.

According to a ninth aspect of the present disclosure, a second network node is provided. The second network node is adapted to perform the method of the above second aspect.

According to a tenth aspect of the present disclosure, a third network node is provided. The third network node comprises a processor and a memory communicatively coupled to the processor. The memory is adapted to store instructions which, when executed by the processor, cause the third network node to perform operations of the method of the above third aspect.

According to an eleventh aspect of the present disclosure, a third network node is provided. The third network node is adapted to perform the method of the above third aspect.

According to a twelfth aspect of the present disclosure, a fourth network node is provided. The fourth network node comprises a processor and a memory communicatively coupled to the processor. The memory is adapted to store instructions which, when executed by the processor, cause the fourth network node to perform operations of the method of the above fourth aspect.

According to a thirteenth aspect of the present disclosure, a fourth network node is provided. The fourth network node is adapted to perform the method of the above fourth aspect.

According to a fourteenth aspect of the present disclosure, a terminal device is provided. The terminal device comprises a processor and a memory communicatively coupled to the processor. The memory is adapted to store instructions which, when executed by the processor, cause the terminal device to perform operations of the method of the above fifth aspect.

According to a fifteenth aspect of the present disclosure, a terminal device is provided. The terminal device is adapted to perform the method of the above fifth aspect.

According to a sixteenth aspect of the present disclosure, a wireless communication system is provided. The wireless communication system comprises: a first network node of the above sixth or seventh aspect; a second network node of the above eighth or ninth aspect, communicating with at least the first network node; a third network node of the above tenth or eleventh aspect, communicating with at least the first network node and the second network node; a fourth network node of the above twelfth or thirteenth aspect, communicating with at least the third network node; and a terminal device of the above fourteenth or fifteenth aspect, communicating with at least the fourth network node.

According to a seventeenth aspect of the present disclosure, a non-transitory computer readable medium having a computer program stored thereon is provided. When the computer program is executed by a set of one or more processors of a first network node, the computer program causes the first network node to perform operations of the method according to the above first aspect.

According to an eighteenth aspect of the present disclosure, a non-transitory computer readable medium having a computer program stored thereon is provided. When the computer program is executed by a set of one or more processors of a second network node, the computer program causes the second network node to perform operations of the method according to the above second aspect.

According to a nineteenth aspect of the present disclosure, a non-transitory computer readable medium having a computer program stored thereon is provided. When the computer program is executed by a set of one or more processors of a third network node, the computer program causes the third network node to perform operations of the method according to the above third aspect.

According to a twentieth aspect of the present disclosure, a non-transitory computer readable medium having a computer program stored thereon is provided. When the computer program is executed by a set of one or more processors of a fourth network node, the computer program causes the fourth network node to perform operations of the method according to the above fourth aspect.

According to a twenty-first aspect of the present disclosure, a non-transitory computer readable medium having a computer program stored thereon is provided. When the computer program is executed by a set of one or more processors of a terminal device, the computer program causes the terminal device to perform operations of the method according to the above fifth aspect.

In this way, the present disclosure may enable NG-RAN to release radio resources at the first time when AF decides to release the multicast session so that the radio resources can be utilized in an efficient way.

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1 is a sequence diagram illustrating removal of configuration for MBS Session;

FIG. 2 is a sequence diagram illustrating UE initiated multicast MBS session leave;

FIG. 3 is a sequence diagram illustrating establishment of shared delivery towards a RAN node;

FIG. 4 is a sequence diagram illustrating release of shared delivery towards a RAN node;

FIG. 5 is a sequence diagram illustrating multicast session deactivation;

FIG. 6 is a sequence diagram illustrating PDU Session modification for multicast;

FIG. 7 is a sequence diagram illustrating MBS session release according to some embodiments of the present disclosure;

FIG. 8 is a sequence diagram illustrating MBS session release according to some embodiments of the present disclosure;

FIG. 9 is a sequence diagram illustrating MBS session release according to some embodiments of the present disclosure;

FIG. 10 is a sequence diagram illustrating MBS session release according to some embodiments of the present disclosure;

FIG. 11 is a sequence diagram illustrating MBS session release according to some embodiments of the present disclosure;

FIG. 12 is a flow chart illustrating a method implemented on a first network node according to some embodiments of the present disclosure;

FIG. 13 is a flow chart illustrating a method implemented on a second network node according to some embodiments of the present disclosure;

FIG. 14 is a flow chart illustrating a method implemented on a third network node according to some embodiments of the present disclosure;

FIG. 15 is a flow chart illustrating a method implemented on a fourth network node according to some embodiments of the present disclosure;

FIG. 16 is a flow chart illustrating a method implemented on a terminal device according to some embodiments of the present disclosure;

FIG. 17 is a block diagram illustrating a first network node according to some embodiments of the present disclosure;

FIG. 18 is another block diagram illustrating a first network node according to some embodiments of the present disclosure;

FIG. 19 is a block diagram illustrating a second network node according to some embodiments of the present disclosure;

FIG. 20 is another block diagram illustrating a second network node according to some embodiments of the present disclosure;

FIG. 21 is a block diagram illustrating a third network node according to some embodiments of the present disclosure;

FIG. 22 is another block diagram illustrating a third network node according to some embodiments of the present disclosure;

FIG. 23 is a block diagram illustrating a fourth network node according to some embodiments of the present disclosure;

FIG. 24 is another block diagram illustrating a fourth network node according to some embodiments of the present disclosure;

FIG. 25 is a block diagram illustrating a terminal device according to some embodiments of the present disclosure;

FIG. 26 is another block diagram illustrating a terminal device according to some embodiments of the present disclosure; and

FIG. 27 is a block diagram illustrating a wireless communication system according to some embodiments of the present disclosure.

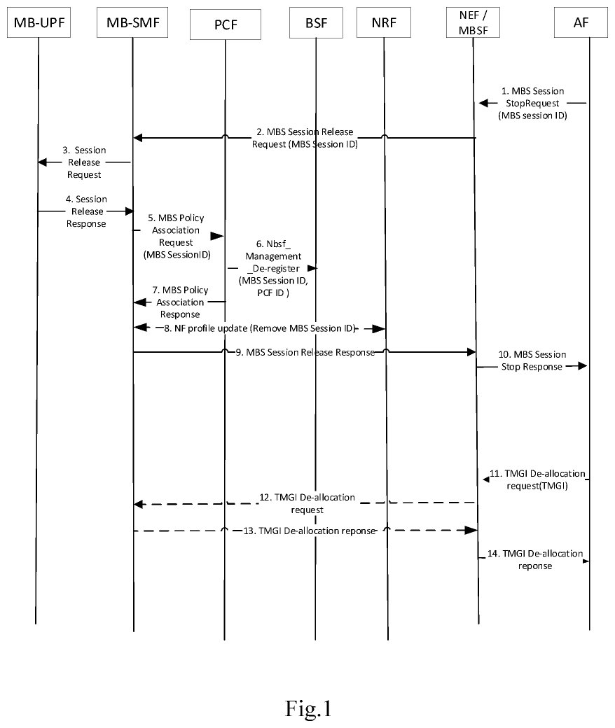

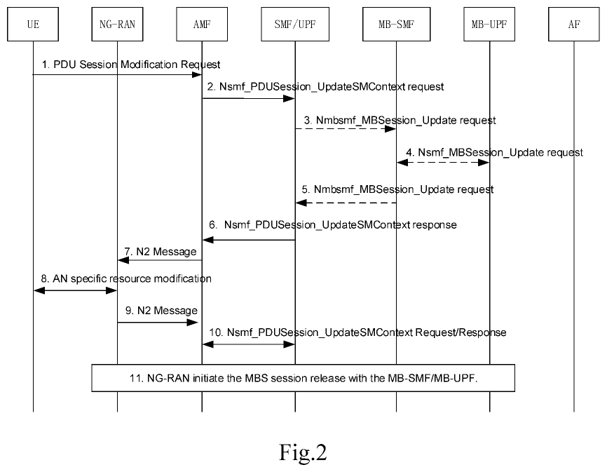

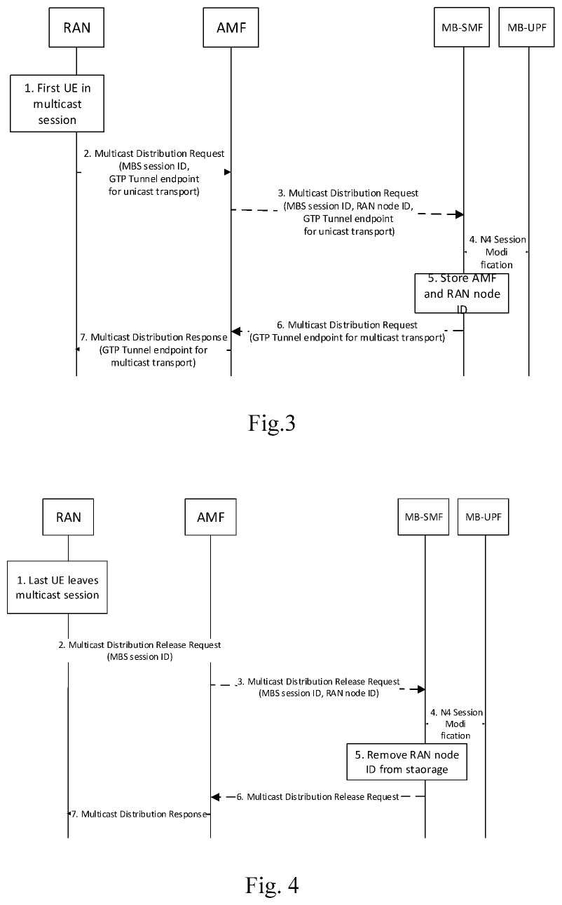

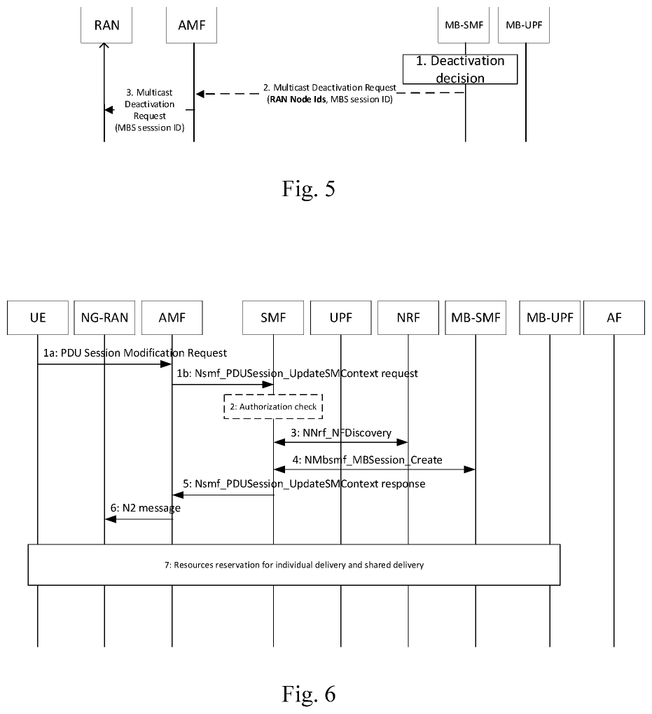

### DETAILED DESCRIPTION

The following detailed description describes methods and devices for MBS session release. In the following detailed description, numerous specific details such as logic implementations, types and interrelationships of system components, etc. are set forth in order to provide a more thorough understanding of the present disclosure. It should be appreciated, however, by one skilled in the art that the present disclosure may be practiced without such specific details. In other instances, control structures, circuits and instruction sequences have not been shown in detail in order not to obscure the present disclosure. Those of ordinary skill in the art, with the included descriptions, will be able to implement appropriate functionality without undue experimentation.

References in the specification to “one embodiment”, “an embodiment”, “an example embodiment” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure.

In the following detailed description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other forms of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interfaces to establish network connections (to transmit and/or receive code and/or data using propagating signals) with other electronic devices. One or more parts of an embodiment of the present disclosure may be implemented using different combinations of software, firmware, and/or hardware.

### Option 0: Basic Solution

When AF triggers MBS session release for a multicast session, it is essential for MB-SMF to trigger session release towards SMFs, so that SMFs can remove all the joined UEs from the MBS session.

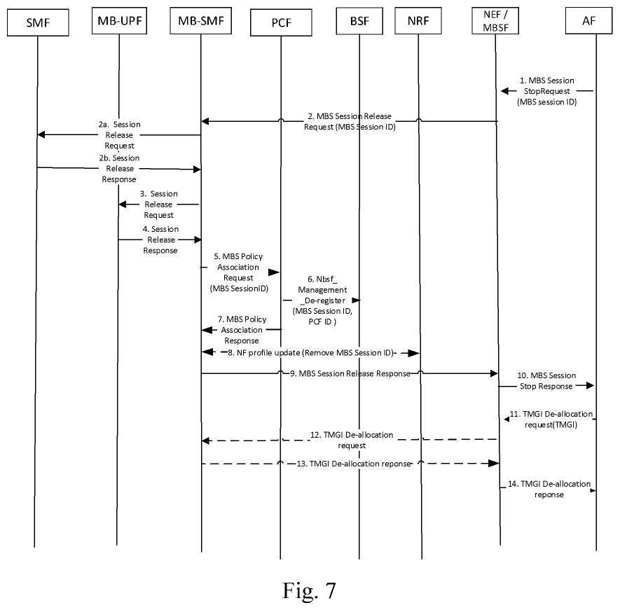

FIG. 7 illustrates procedures prior to SMF removing joined UEs for Option 0.

At step 2a, after receiving an MBS session release request, MB-SMF determines whether the released session is a multicast session or a broadcast session. For multicast session, MB-SMF sends an MBS session release request to SMFs which serve joined UEs.

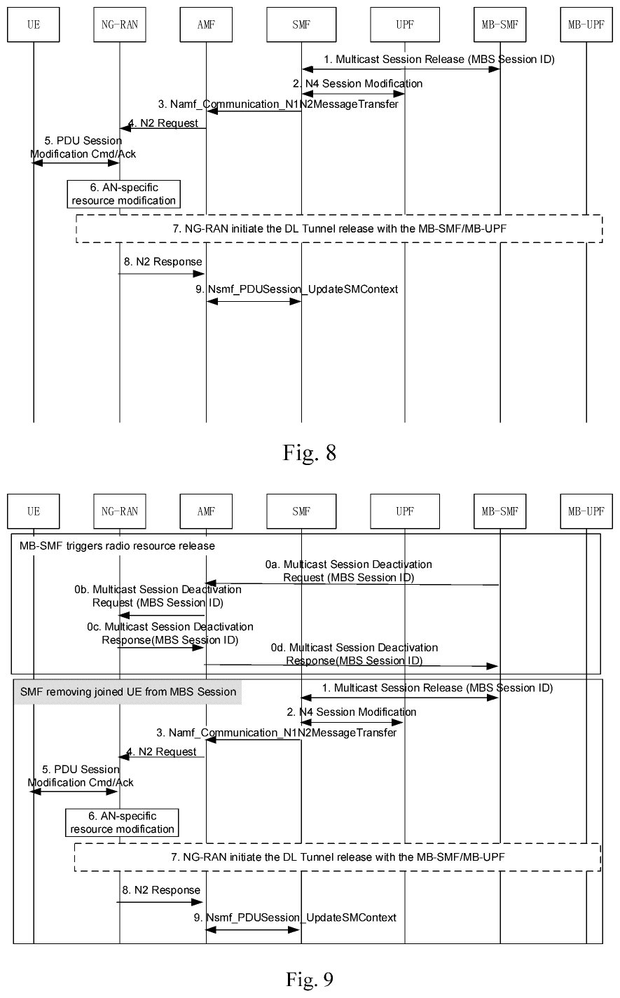

At step 2b, SMF removes joined UEs from the MBS session as illustrated in FIG. 8 below, and sends an MBS session release response towards MB-SMF.

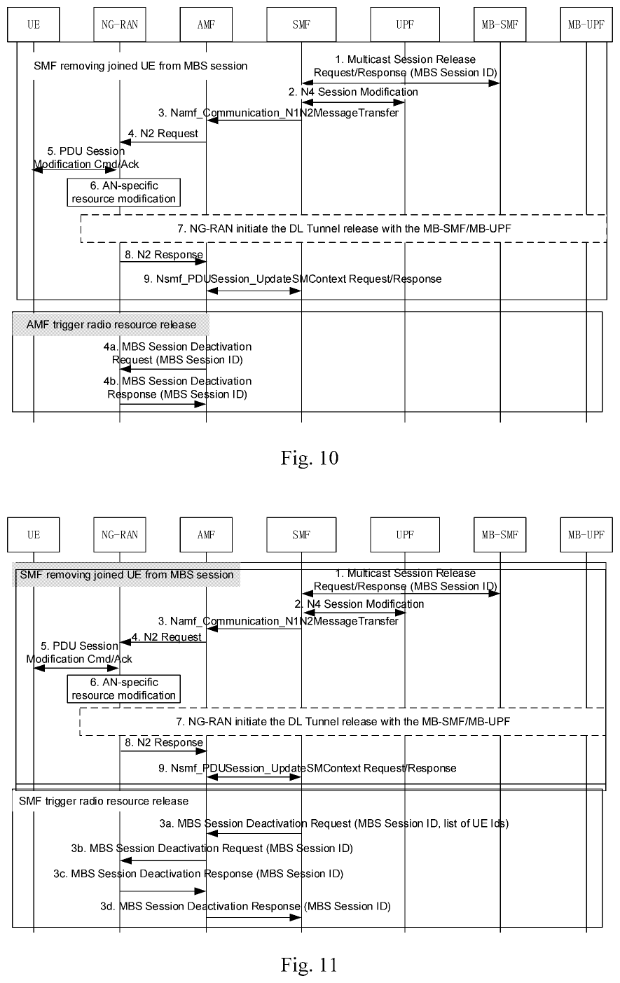

The MBS session release request in step 2a of FIG. 7 is the Multicast Session Release request in step 1 of FIG. 8, FIG. 9, FIG. 10 and FIG. 11. The MBS session release response in step 2b of FIG. 7. is the Multicast Session Release response in step 1 of FIG. 8, FIG. 9, FIG. 10 and FIG. 11.

FIG. 8 illustrates the procedure of SMF removing joined UEs from MBS session for Option 0.

At step 1, the SMF receives Multicast Session Release request from the MB-SMF with MBS Session ID. The SMF checks joined UEs. The SMF sends Multicast Session Release response to the MB-SMF.

At step 2, for each joined UEs, the SMF sends N4 Session Modification Request to the UPF. The UPF releases the user plane resources and sends N4 Session Modification Response to the SMF.

At step 3, for each joined UEs, the SMF invokes Namf_Communicate_N1N2MessageTransfer to the AMF. The N1 SM container indicates MBS session release. In N2 SM information, the SMF informs the NG-RAN to remove the UE from the MBS session.

At step 4, the AMF sends N2 Request to the NG-RAN.

At step 5, the NG-RAN transports the N1 SM container (PDU Session Modification Command) to the UE.

At step 6, the NG-RAN performs radio resource modification. If there are no joined UEs in the MBS session, the NG-RAN releases the radio resources.

At step 7, if there are no joined UEs in the MBS session, for unicast transport of N3mb, the NG-RAN initiates the DL (downlink) tunnel release towards MB-UPF via AMF and MB-SMF. For multicast transportation of N3mb, the NG-RAN performs IGMP/MLD Leave for the MBS session.

At step 8, the NG-RAN sends N2 Response to the AMF. If there are no joined UEs in the MBS session, the MBS Session context is removed from the NG-RAN.

At step 9, the AMF transfers the N2 message received in step 8 to the SMF via the Nsmf_PDUSession_UpdateSMContext service operation. The SMF removes the UE from the MBS Session.

In Option 0, the NG-RAN may release radio resources when the last UE is removed from the MBS session. After a session stop request from the AF, the AF will no longer deliver content over the MBS session. It may take a while for the SMFs to remove those joined UEs. During this period, the radio resources are not released.

To enable the radio resources to be released as early as possible, Option 0 may be further improved.

### Option 1: Indication in N2 Information for the PDU Session Modification Command

The SMF indicates the NG-RAN session stop in N2 information. The NG-RAN recognizes the MBS session stop and then releases the radio resources when receiving a request for first UE.

The call flow of Option 1 is similar to that of Option 0. The differences are:
In Option 0, the NG-RAN releases radio resources of the MBS session when the last UE is removed from the MBS session.
In Option 1, the NG-RAN recognizes the MBS session stop and releases radio resources of the MBS session when the first UE is removed from the MBS session due to MBS session stop.

### Option 2: Utilize MBS Session Deactivation Request or Introduce MBS Session Release Request Message

### Option 2-A: MB-SMF Sends MBS Session Deactivation/Release Request to NG-RAN Via AMF

Before triggering the SMFs, the MB-SMF sends MBS Session Deactivation request to the AMF and the AMF distributes it to the NG-RAN. When receiving the MBS Session Deactivation request, the NG-RAN releases the radio resources.

The prerequisite of Option 2-A is that the MB-SMF is aware of the involved NG-RANs, or that the MB-SMF is aware of the involved AMFs and the AMFs are aware of the involved NG-RANs.

FIG. 9 illustrates the procedure of MB-SMF triggering radio resource release for Option 2-A.

MB-SMF may trigger the multicast session deactivation procedure prior to the steps of SMF removing joined UE from MBS Session as shown in FIG. 8. When MB-SMF decides to release the MBS session, it triggers the multicast session deactivation as shown in step 0a to step 0d.

At step 0a, the MB-SMF sends Multicast Session Deactivation Request to the AMF with the MBS Session ID.

At step 0b, the AMF sends the request to the NG-RAN.

At step 0c, The NG-RAN releases the radio resources of the MBS session and sends Multicast Session Deactivation Response to the AMF. The MBS session context is kept in the NG-RAN, which will be released at step 6 when there are no served UEs.

At step 0d, the AMF sends the response to the MB-SMF.

Alternatively, the MB-SMF may send Multicast Session Release Request to the AMF, instead of Multicast Session Deactivation Request. In this case, from step 0a to step 0d, the messages are Multicast Session Release Request or Response. In step 0c, the NG-RAN should not only release the radio resource of the MBS session, but also remove the MBS session context.

### Option 2-B: AMF Involved in the Session Management of Shared Delivery, AMF Triggers Radio Resource Release

In this option, AMF is involved in the session management for shared delivery. In the procedure of MBS join and session establishment, the AMF may obtain the UE join information from the SMF.

FIG. 10 illustrates the procedure of AMF triggering radio resource release for Option 2-B.

At step 3, the SMF informs the AMF that the UE is to be removed from the MBS session due to MBS session release initiated by the AF.

Compared with Option 0, the differences are described as follows:
In parallel with or prior to step 4, the AMF triggers radio resource release towards the NG-RAN in step 4a and step 4b:
   At step 4a, the AMF sends MBS Session Deactivation Request to the NG-RANs serving joined UEs with MBS Session ID.
   At step 4b, the NG-RAN releases radio resources for the MBS session and sends MBS Session Deactivation Response to the AMF. At this step, the NG-RAN only releases radio resources based on the Multicast Session Deactivation Request from the AMF. The MBS session context including the DL tunnel in NG-RAN may not be impacted by this request.

Alternatively, at step 4a, the AMF may send Multicast Session Release request to the NG-RAN, and then at step 4b, the NG-RAN should release the radio resource of the MBS session, as well as remove MBS session context.

### Option 2-C: AMF is Not Involved in the Session Management of Shared Delivery, SMF Triggers Radio Resource Release

In this option, AMF is not involved in the session management for shared delivery. It means that AMF has no knowledge about the UE join information of the MBS session.

FIG. 11 illustrates the procedure of SMF triggering radio resource release for Option 2-C.

To enable the radio resource to be released as early as possible, after receiving MBS Session Release Request from the MB-SMF, in parallel with or prior to step 3, SMF needs to trigger radio resource release in step 3a to step 3d.

At step 3a, the SMF sends MBS Session Deactivation Request to the AMFs with the MBS Session ID and the list of UE Ids. The list of UE Ids includes the UEs served by the SMF who have joined the MBS session.

At step 3b, based on the list of UE Ids, the AMF determines the involved NG-RANs. For each NG-RAN, the AMF sends MBS Session Deactivation Request with the MBS Session ID.

At step 3c, the NG-RAN releases the radio resource for the MBS session and sends MBS Session Deactivation Response. At this step, the NG-RAN only releases radio resources based on the Multicast Session Release Request from the AMF. The MBS session context including the DL tunnel in NG-RAN may not be impacted by this request. It will be released when there are no served UEs at step 6.

At step 3d, the AMF sends MBS Session Deactivation Response to the SMF.

Alternatively, the SMF may send Multicast Session Release Request to the AMF, instead of Multicast Session Deactivation Request. In this case, from step 3a to step 3d, the messages are Multicast Session Release Request or Response. At step 3c, the NG-RAN should release the radio resource of the MBS session, as well as remove the MBS session context.

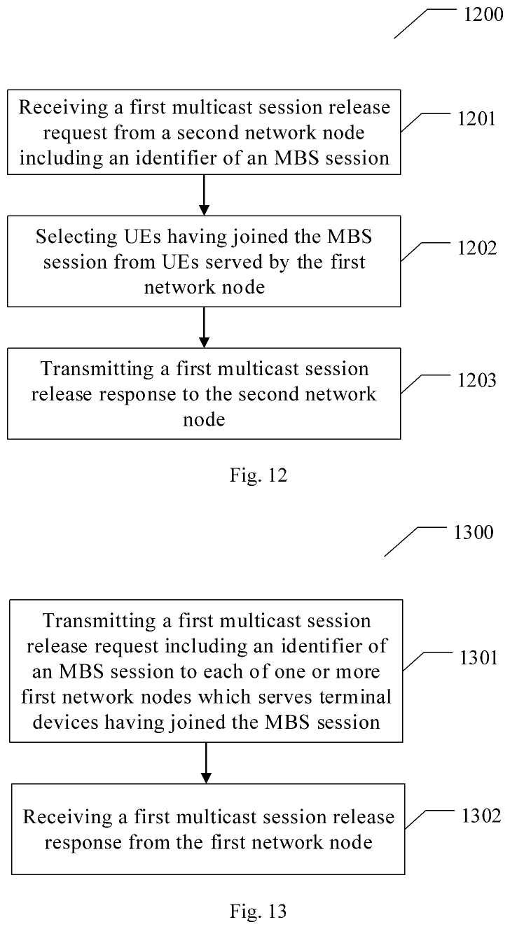

FIG. 12 is a flow chart illustrating a method 1200 implemented on a first network node according to some embodiments of the present disclosure. As an example, operations of this flow chart may be performed by an SMF, but they are not limited thereto. The operations in this and other flow charts will be described with reference to the exemplary embodiments of the other figures. However, it should be appreciated that the operations of the flow charts may be performed by embodiments of the present disclosure other than those discussed with reference to the other figures, and the embodiments of the present disclosure discussed with reference to these other figures may perform operations different than those discussed with reference to the flow charts.

In one embodiment, the first network node may receive a first multicast session release request from a second network node including an identifier of an MBS session (block 1201). The first network node may select UEs having joined the MBS session from UEs served by the first network node (block 1202). The first network node may then transmit a first multicast session release response to the second network node (block 1203).

As an example, the method 1200 may further comprise:
transmitting an N4 session modification request to a user plane function for release of user plane resources.

As an example, the method 1200 may further comprise:
transmitting a communication message to a third network node including an N1 SF container which indicates release of the MBS session and N2 SF information which is to inform a fourth network node of removal of a predetermined UE of the selected UEs, which is associated with the fourth network node, from the MBS session.

As a further example, the N2 SM information may include a session stop for the fourth network node to release radio resources of the MBS session.

As a further example, in the case that the third network node is not aware of involved fourth network nodes, in parallel to or prior to the transmission of the communication message, the method 1200 may further comprise:
transmitting a second multicast session deactivation or release request to the third network node including the identifier of the MBS session and a list of identifiers of the selected UEs; and
receiving a second multicast session deactivation or release response from the third network node.

As an example, the first network node may be an SMF and the second network node may be a MB-SMF.

As a further example, the third network node may be an AMF and the fourth network node may be an NG-RAN.

Furthermore, the present disclosure provides a first network node which is adapted to perform the method 1200.

FIG. 13 is a flow chart illustrating a method 1300 implemented on a second network node according to some embodiments of the present disclosure.

In one embodiment, the second network node may transmit a first multicast session release request including an identifier of an MBS session to each of one or more first network nodes which serves UEs having joined the MBS session (block 1301). The second network node may receive a first multicast session release response from the first network node (block 1302).

As an example, in the case that the second network node is aware of involved fourth network nodes or that the second network node is aware of involved third network nodes which are aware of the involved fourth network nodes, prior to the transmission of the first multicast session release request, the method 1300 may further comprise:
in the case that the second network node decides to release the MBS session, transmitting a second multicast session deactivation or release request to a third network node associated with the identifier of the MBS session; and
receiving a second multicast session deactivation or release response from the third network node.

As an example, the first network node may be an SMF and the second network node may be a MB-SMF.

As a further example, the third network node may be an AMF and the fourth network node may be an NG-RAN.

Furthermore, the present disclosure provides a second network node which is adapted to perform the method 1300.

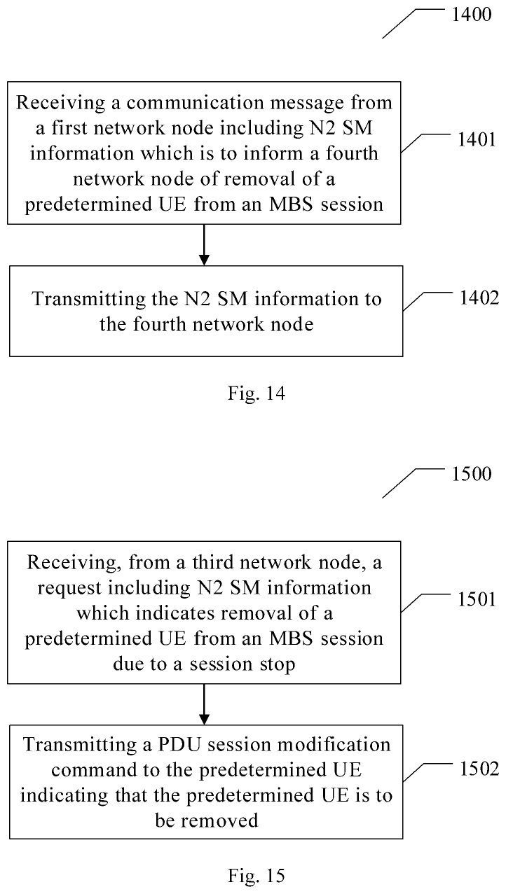

FIG. 14 is a flow chart illustrating a method 1400 implemented on a third network node according to some embodiments of the present disclosure.

In one embodiment, the third network node may receive a communication message from a first network node including N2 SM information which is to inform a fourth network node of removal of a predetermined UE from an MBS session (block 1401). The third network node may transmit the N2 SM information to the fourth network node (block 1402).

As an example, the communication message may further include an N1 SM container which indicates release of the MBS session.

As an example, the N2 SM information may include a session stop for the fourth network node to release radio resources of the MBS session.

As an example, in the case that a second network node is aware of involved fourth network nodes or that the second network node is aware of involved third network nodes which are aware of the involved fourth network nodes, prior to the reception of the communication message, the method 1400 may further comprise:
receiving a first multicast session deactivation or release request from a second network node including an identifier of the MBS session;
transmitting a second multicast session deactivation or release request to the fourth network node including the identifier of the MBS session;
receiving a second multicast session deactivation or release response from the fourth network node; and
transmitting a first multicast session deactivation or release response to the second network node.

As an example, in the case that the third network node is aware of involved fourth network nodes, in parallel to or prior to the transmission of the N2 session management information, the method 1400 may further comprise:
transmitting a third multicast session deactivation or release request to the fourth network node including an identifier of the MBS session; and
receiving a third multicast session deactivation or release response from the fourth network node.

As an example, in the case that the third network node is not aware of involved fourth network nodes, in parallel to or prior to the reception of the communication message, the method 1400 may further comprise:
receiving a fourth multicast session deactivation or release request from the first network node including an identifier of the MBS session and a list of identifiers of UEs having joined the MBS session and served by the first network node;
determining the fourth network nodes based on the list of identifiers of the UEs;
transmitting a fifth multicast session deactivation or release request to each of the fourth network nodes;
receiving a fifth multicast session deactivation or release response from this fourth network node; and
transmitting a fourth multicast session deactivation or release response to the first network node.

As an example, the first network node may be an SMF, the third network node may be an AMF, and the fourth network node may be an NG-RAN.

As a further example, the second network node may be an MB-SMF.

Furthermore, the present disclosure provides a third network node which is adapted to perform the method 1400.

FIG. 15 is a flow chart illustrating a method 1500 implemented on a fourth network node according to some embodiments of the present disclosure.

In one embodiment, the fourth network node may receive, from a third network node, a request including N2 SM information which indicates removal of a predetermined UE from an MBS session due to a session stop (block 1501). The fourth network node may transmit a PDU session modification command to the predetermined UE indicating that the predetermined UE is to be removed (block 1502).

As an example, the method 1500 may further comprise:
releasing radio resources of the MBS session in the case that the predetermined UE is the last UE to be removed from the MBS session.

As an example, the method 1500 may further comprise:
releasing radio resources of the MBS session based on the session stop in the case that the predetermined UE is a UE to be firstly removed.

As an example, wherein in the case that a second network node is aware of involved fourth network nodes or that the second network node is aware of involved third network nodes which are aware of the involved fourth network nodes, prior to the reception of the request, the method 1500 may further comprise:
receiving a first multicast session deactivation or release request from the third network node including the identifier of the MBS session;
releasing radio resources of the MBS session; and
transmitting a first multicast session deactivation or release response to the third network node.

As an example, in the case that the third network node is aware of involved fourth network nodes, in parallel to or prior to the reception of the request, the method 1500 may further comprise:
receiving a second multicast session deactivation or release request from the third network node including an identifier of the MBS session;
releasing radio resources of the MBS session; and
transmitting a second multicast session deactivation or release response to the third network node.

As an example, in the case that the third network node is not aware of involved fourth network nodes, in parallel to or prior to the reception of the request, the method 1500 may further comprise:
receiving a third multicast session deactivation or release request transmitted from the third network node based on a list of identifiers of the UEs from a second network node;
releasing radio resources of the MBS session; and
transmitting a third multicast session deactivation or release response to the third network node.

As an example, the third network node may be an AMF and the fourth network node may be an NG-RAN.

As a further example, the first network node may be an SMF and the second network node may be a MB-SMF.

Furthermore, the present disclosure provides a fourth network node which is adapted to perform the method 1500.

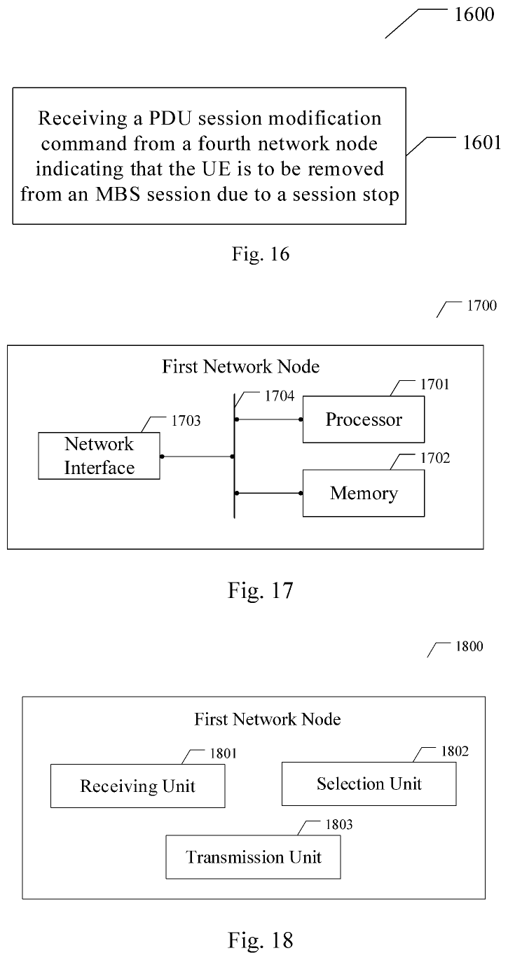

FIG. 16 is a flow chart illustrating a method 1600 implemented on a terminal device according to some embodiments of the present disclosure. As an example, operations of this flow chart may be performed by a UE, but they are not limited thereto.

In one embodiment, the UE may receive a PDU session modification command from a fourth network node indicating that the UE is to be removed from an MBS session due to a session stop.

As an example, the fourth network node is an NG-RAN.

Furthermore, the present disclosure provides a terminal device which is adapted to perform the method 1600.

FIG. 17 is a block diagram illustrating a first network node 1700 according to some embodiments of the present disclosure. As an example, the first network node 1700 may act as an SMF, but it is not limited thereto. It should be appreciated that the first network node 1700 may be implemented using components other than those illustrated in FIG. 17.

With reference to FIG. 17, the first network node 1700 may comprise at least a processor 1701, a memory 1702, a network interface 1703 and a communication medium 1704. The processor 1701, the memory 1702 and the network interface 1703 may be communicatively coupled to each other via the communication medium 1704.

The processor 1701 may include one or more processing units. A processing unit may be a physical device or article of manufacture comprising one or more integrated circuits that read data and instructions from computer readable media, such as the memory 1702, and selectively execute the instructions. In various embodiments, the processor 1701 may be implemented in various ways. As an example, the processor 1701 may be implemented as one or more processing cores. As another example, the processor 1701 may comprise one or more separate microprocessors. In yet another example, the processor 1701 may comprise an application-specific integrated circuit (ASIC) that provides specific functionality. In still another example, the processor 1701 may provide specific functionality by using an ASIC and/or by executing computer-executable instructions.

The memory 1702 may include one or more computer-usable or computer-readable storage medium capable of storing data and/or computer-executable instructions. It should be appreciated that the storage medium is preferably a non-transitory storage medium.

The network interface 1703 may be a device or article of manufacture that enables the first network node 1700 to send data to or receive data from other devices. In different embodiments, the network interface 1703 may be implemented in different ways. As an example, the network interface 1703 may be implemented as an Ethernet interface, a token-ring network interface, a fiber optic network interface, a network interface (e.g., Wi-Fi, WiMax, etc.), or another type of network interface.

The communication medium 1704 may facilitate communication among the processor 1701, the memory 1702 and the network interface 1703. The communication medium 1704 may be implemented in various ways. For example, the communication medium 1704 may comprise a Peripheral Component Interconnect (PCI) bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium.

In the example of FIG. 17, the instructions stored in the memory 1702 may include those that, when executed by the processor 1701, cause the first network node 1700 to implement the method described with respect to FIG. 12. FIG. 18 is another block diagram illustrating a first network node 1800 according to some embodiments of the present disclosure. As an example, the first network node 1800 may act as an SMF, but it is not limited thereto. It should be appreciated that the first network node 1800 may be implemented using components other than those illustrated in FIG. 18.

With reference to FIG. 18, the first network node 1800 may comprise at least a receiving unit 1801, a selection unit 1802 and a transmission unit 1803. The receiving unit 1801 may be adapted to perform at least the operation described in the block 1201 of FIG. 12. The selection unit 1802 may be adapted to perform at least the operation described in the block 1202 of FIG. 12. The transmission unit 1803 may be adapted to perform at least the operation described in the block 1203 of FIG. 13.

FIG. 19 is a block diagram illustrating a second network node 1900 according to some embodiments of the present disclosure. As an example, the second network node 1900 may act as an MB-SMF, but it is not limited thereto. It should be appreciated that the second network node 1900 may be implemented using components other than those illustrated in FIG. 19.

With reference to FIG. 19, the second network node 1900 may comprise at least a processor 1901, a memory 1902, a network interface 1903 and a communication medium 1904. The processor 1901, the memory 1902 and the network interface 1903 are communicatively coupled to each other via the communication medium 1904.

The processor 1901, the memory 1902, the network interface 1903 and the communication medium 1904 are structurally similar to the processor 1701, the memory 1702, the network interface 1703 and the communication medium 1704 respectively, and will not be described herein in detail.

In the example of FIG. 19, the instructions stored in the memory 1902 may include those that, when executed by the processor 1901, cause the second network node 1900 to implement the method described with respect to FIG. 13.

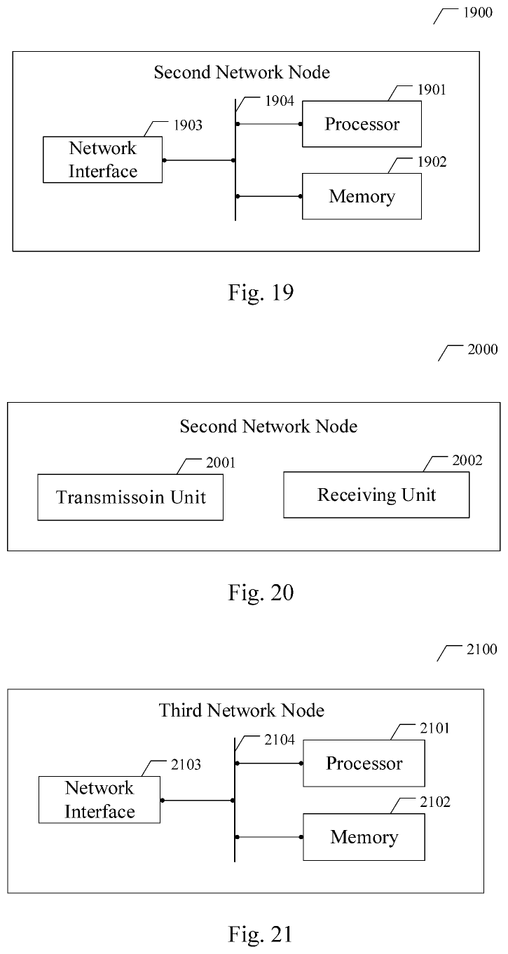

FIG. 20 is another block diagram illustrating a second network node 2000 according to some embodiments of the present disclosure. As an example, the second network node 2000 may act as an MB-SMF, but it is not limited thereto. It should be appreciated that the second network node 2000 may be implemented using components other than those illustrated in FIG. 20.

With reference to FIG. 20, the second network node 2000 may comprise at least a transmission unit 2001 and a receiving unit 2002. The transmission unit 2001 may be adapted to perform at least the operation described in the block 1301 of FIG. 13. The receiving unit 2002 may be adapted to perform at least the operation described in the block 1302 of FIG. 13.

FIG. 21 is a block diagram illustrating a third network node 2100 according to some embodiments of the present disclosure. As an example, the third network node 2100 may act as an AMF, but it is not limited thereto. It should be appreciated that the third network node 2100 may be implemented using components other than those illustrated in FIG. 21.

With reference to FIG. 21, the third network node 2100 may comprise at least a processor 2101, a memory 2102, a network interface 2103 and a communication medium 2104. The processor 2101, the memory 2102 and the network interface 2103 are communicatively coupled to each other via the communication medium 2104.

The processor 2101, the memory 2102, the network interface 2103 and the communication medium 2104 are structurally similar to the processor 1701 or 1901, the memory 1702 or 1902, the network interface 1703 or 1903 and the communication medium 1704 or 1904 respectively, and will not be described herein in detail.

In the example of FIG. 21, the instructions stored in the memory 2102 may include those that, when executed by the processor 2101, cause the third network node 2100 to implement the method described with respect to FIG. 14.

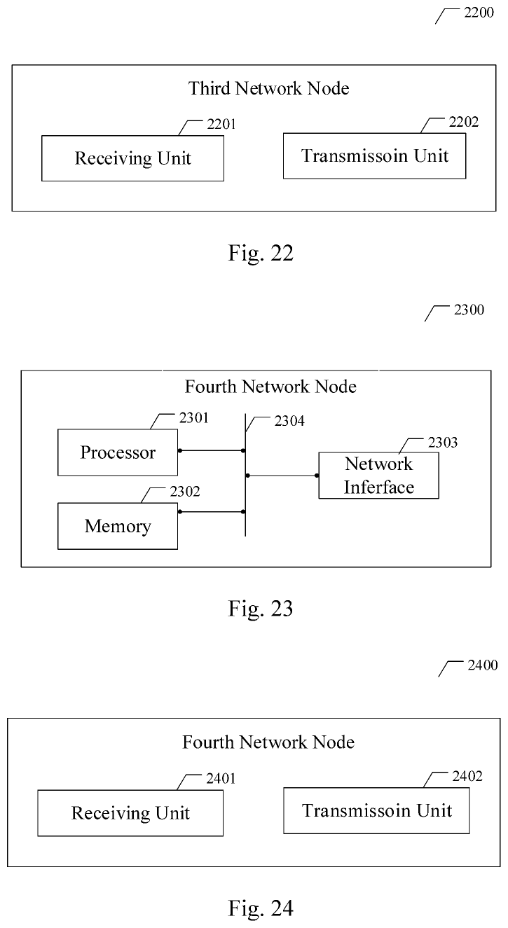

FIG. 22 is another block diagram illustrating a third network node 2200 according to some embodiments of the present disclosure. As an example, the third network node 2200 may act as an AMF, but it is not limited thereto. It should be appreciated that the third network node 2200 may be implemented using components other than those illustrated in FIG. 22.

With reference to FIG. 22, the third network node 2200 may comprise at least a receiving unit 2201 and a transmission unit 2202. The receiving unit 2201 may be adapted to perform at least the operation described in the block 1401 of FIG. 14. The transmission unit 2202 may be adapted to perform at least the operation described in the block 1402 of FIG. 14.

FIG. 23 is a block diagram illustrating a fourth network node 2300 according to some embodiments of the present disclosure. As an example, the fourth network node 2300 may act as an NG-RAN, but it is not limited thereto. It should be appreciated that the fourth network node 2300 may be implemented using components other than those illustrated in FIG. 23.

With reference to FIG. 23, the fourth network node 2300 may comprise at least a processor 2301, a memory 2302, a network interface 2303 and a communication medium 2304. The processor 2301, the memory 2302 and the network interface 2303 are communicatively coupled to each other via the communication medium 2304.

The processor 2301, the memory 2302, the network interface 2303 and the communication medium 2304 are structurally similar to the processor 1701, 1901 or 2101, the memory 1702, 1902 or 2102, the network interface 1703, 1903 or 2103 and the communication medium 1704, 1904 or 2104 respectively, and will not be described herein in detail.

In the example of FIG. 23, the instructions stored in the memory 2302 may include those that, when executed by the processor 2301, cause the fourth network node 2300 to implement the method described with respect to FIG. 15.

FIG. 24 is another block diagram illustrating a fourth network node 2400 according to some embodiments of the present disclosure. As an example, the fourth network node 2400 may act as an NG-RAN, but it is not limited thereto. It should be appreciated that the fourth network node 2400 may be implemented using components other than those illustrated in FIG. 24.

With reference to FIG. 24, the fourth network node 2400 may comprise at least a receiving unit 2401 and a transmission unit 2402. The receiving unit 2401 may be adapted to perform at least the operation described in the block 1501 of FIG. 15. The transmission unit 2402 may be adapted to perform at least the operation described in the block 1502 of FIG. 15.

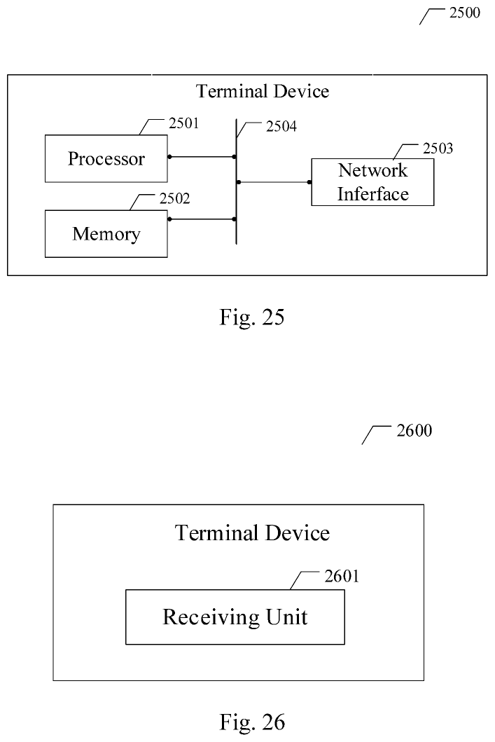

FIG. 25 is a block diagram illustrating a terminal device 2500 according to some embodiments of the present disclosure. As an example, the terminal device 2500 may act as a UE, but it is not limited thereto. It should be appreciated that the terminal device 2500 may be implemented using components other than those illustrated in FIG. 25.

With reference to FIG. 25, the terminal device 2500 may comprise at least a processor 2501, a memory 2502, a network interface 2503 and a communication medium 2504. The processor 2501, the memory 2502 and the network interface 2503 are communicatively coupled to each other via the communication medium 2504.

The processor 2501, the memory 2502, the network interface 2503 and the communication medium 2504 are structurally similar to the processor 1701, 1901, 2101 or 2301, the memory 1702, 1902, 2102 or 2302, the network interface 1703, 1903, 2103 or 2303 and the communication medium 1704, 1904, 2104 or 2304 respectively, and will not be described herein in detail.

In the example of FIG. 25, the instructions stored in the memory 2502 may include those that, when executed by the processor 2501, cause the terminal device 2500 to implement the method described with respect to FIG. 16.

FIG. 26 is another block diagram illustrating a terminal device 2600 according to some embodiments of the present disclosure. As an example, the terminal device 2600 may act as a UE, but it is not limited thereto. It should be appreciated that the terminal device 2600 may be implemented using components other than those illustrated in FIG. 26.

With reference to FIG. 26, the terminal device 2600 may comprise at least a receiving unit 2601. The receiving unit 2601 may be adapted to perform at least the operation described in the block 1601 of FIG. 16.

The units shown in FIGS. 18, 20, 22, 24 and 26 may constitute machine-executable instructions embodied within a machine, e.g., readable medium, which when executed by a machine will cause the machine to perform the operations described. Besides, any of these units may be implemented as hardware, such as an application specific integrated circuit (ASIC), Digital Signal Processor (DSP), Field Programmable Gate Array (FPGA) or the like.

Moreover, it should be appreciated that the arrangements described herein are set forth only as examples. Other arrangements (e.g., more controllers or more detectors, etc.) may be used in addition to or instead of those shown, and some units may be omitted altogether. Functionality and cooperation of these units are correspondingly described in more detail with reference to FIGS. 12-16.

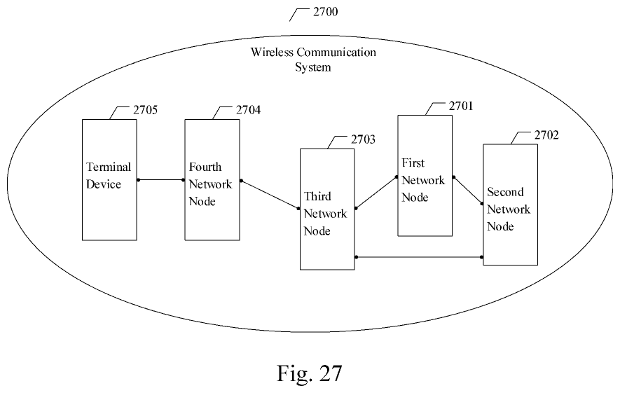

FIG. 27 is a block diagram illustrating a wireless communication system 2700 according to some embodiments of the present disclosure. The wireless communication system 2700 comprises at least a first network node 2701, a second network node 2702, a third network node 2703, a fourth network node 2704 and a terminal device 2705. In one embodiment, the first network node 2701 may act as the first network node 1700 or 1800 as depicted in FIG. 17 or 18, the second network node 2702 may act as the second network node 1900 or 2000 as depicted in FIG. 19 or 20, the third network node 2703 may act as the third network node 2100 or 2200 as depicted in FIG. 21 or 22, the fourth network node 2704 may act as the fourth network node 2300 or 2400 as depicted in FIG. 23 or 24, and the terminal device 2705 may act as the terminal device 2500 or 2600 as depicted in FIG. 25 or 26. In one embodiment, the first network node 2701, the second network node 2702 and the third network node 2703 may communicate with each other, the fourth network node 2704 may communicate with at least the third network node 2703 and the terminal device 2705.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

### Discussion

In clause 7.1.1.2 which is common procedure for removal of MBS session, when AF sends MBS Session Stop Request, the procedure stops at MB-SMF/MB-UPF, which is incomplete. Update is proposed in S2-2103976 to complete the procedure by referring to clauses of multicast and broadcast.

For multicast session, when the MBS session is removed, the MB-SMF shall trigger the session stop activities towards the SMFs if there are still joined UEs. And the SMFs should remove those UEs from the MBS session and release the resources for both 5GC individual delivery and 5GC shared delivery.

[Proposal-1] Introduce a new sub-clause 7.2.2.X within 7.2.2 “MBS leave and Session release procedure” to describe how SMF removes joined UEs from MBS session.

To inform the joined UE of its removal from an MBS Session the SMF needs to do it one by one using per PDU session signaling. To release radio resource for shared delivery, however, there could be some optimizations. Several options are discussed below:

Option-1: The shared delivery resource is released in per PDU session manner. That is, the SMF removes the UEs from the MBS session distribution per PDU session. When the last UE in the NG-RAN is removed from the MBS session distribution, the NG-RAN release radio resources and remove MBS session context (including the MB-N3 tunnel release)
1. The SMF receives Multicast Session Release request from the MB-SMF with MBS Session ID. The SMF checks joined UEs. The SMF sends Multicast Session Release response to the MB-SMF
2. For each joined UEs, the SMF sends N4 Session Modification Request to the UPF. The UPF release the user plane resources and sends the N4 Session Modification Response to the SMF.
3. For each joined UEs, the SMF invokes Namf_Communicate_N1N2MessageTransfer to the AMF. The N1 SM container indicates MBS session release. In N2 SM information, the SMF informs the NG-RAN to remove the UE from the MBS session.
4. The AMF sends N2 Request to the NG-RAN
5. The NG-RAN transports the N1 SM container (PDU Session Modification Command) to the UE.
6. The NG-RAN performs radio resource modification. If there are no joined in the MBS session, the NG-RAN release the radio resources.
7. If there are no joined UEs in the MBS session, for unicast transport of N3mb, the NG-RAN initiates the DL tunnel release towards MB-UPF via AMF and MB-SMF. For multicast transportation of N3mb, the NG-RAN perform IGMP/MLD Leave for the MBS session.
8. The NG-RAN sends N2 Response to the AMF. If there are no joined UEs in the MBS session, the MBS Session context is removed from the NG-RAN.
9. The AMF transfers the N2 message received in step 8 to the SMF via the Nsmf_PDUSession_UpdateSMContext service operation. The SMF removes the UE from the MBS Session.

The drawback of Option-1 is that the NG-RAN can only release radio resources when the last UE is removed from the MBS session although it is clear in 5GC that the AF will no longer deliver content over the MBS session. Depending on the number of the joined UEs in the NG-RAN, release of radio resource for MBS Session may be delayed unnecessarily.

To enable the radio resources to be released as early as possible, Option-1 can be further improved.

Option-2: The SMF indicates the NG-RAN session stop in N2 info. The NG-RAN recognize the MBS session stop and then release the radio resources when receiving request for first UE. The call flow of Option-2 is the same is the Option-1. The differences are:
In Option-1, the NG-RAN release radio resources of the MBS session when the last UE is removed from the MBS session.
In Option-2, the NG-RAN recognize the MBS session stop and release radio resources of the MBS session when the first UE is removed from the MBS session due to MBS session stop.

Option-3: Before triggering the SMFs, the MB-SMF sends MBS session stop request to the AMF and the AMF distribute to the NG-RAN. When receiving the MBS session stop request, the NG-RAN release the radio resources.

The prerequisite of Option-3 is the MB-SMF is aware of the involved NG-RANs, or the MB-SMF is aware of the involved AMFs and the AMFs are aware of the involved NG-RANs

MB-SMF can trigger “multicast session deactivation” procedure prior to the steps of “SMF removing joined UE from MBS Session”. When MB-SMF decides to release the MBS session, it triggers “multicast session deactivation” as step 0a. to step 0d.:

0a. The MB-SMF sends Multicast Session Deactivation Request to the AMF with the MBS Session ID.

0b. The AMF sends the request to the NG-RAN

0c. The NG-RAN release the radio resources of the MBS session and sends Multicast Session Deactivation Response to the AMF. The MBS session context is kept in the NG-RAN, which will be released in step 6 when there are no served UEs.

0d. The AMF sends the response to the MB-SMF

The “SMF removing joined UE from MBS session” procedure is depicted as below:
1. The SMF receives Multicast Session Release request from the MB-SMF with MBS Session ID. The SMF checks joined UEs. The SMF sends Multicast Session Release response to the MB-SMF
2. For each joined UEs, the SMF sends N4 Session Modification Request to the UPF. The UPF release the user plane resources and sends the N4 Session Modification Response to the SMF.
3. For each joined UEs, the SMF invokes Namf_Communicate_N1N2MessageTransfer to the AMF. The N1 SM container indicates MBS session release. In N2 SM information, the SMF informs the NG-RAN to remove the UE from the MBS session.
4. The AMF sends N2 Request to the NG-RAN
5. The NG-RAN transports the N1 SM container (PDU Session Modification Command) to the UE.
6. The NG-RAN performs radio resource modification. If there are no joined UEs in the MBS session, the NG-RAN releases the radio resources.
   The radio resource may already have been released by the NG-RAN when the Multicast Session Deactivation Request is received
7. If no joined UEs in the MBS session, for unicast transport of N3mb, the NG-RAN initiates the DL tunnel release towards MB-UPF via AMF and MB-SMF. For multicast transportation of N3mb, the NG-RAN performs IGMP/MLD Leave for the MBS session.
8. The NG-RAN sends N2 Response to the AMF. If no joined UEs in the MBS session, the MBS Session context is removed from the NG-RAN.
9. The AMF transfers the N2 message received in step 8 to the SMF via the Nsmf_PDUSession_UpdateSMContext service operation. The SMF removes the UE from the MBS Session.

### Comparison:

Option-1 is not optimized. The radio resource release of shared delivery can only be triggered when the last joined UE is removed from the MBS session by the MB-SMF.

Option-2 and Option-3 are optimized, so that the radio resources of the MBS session can be released as early as possible.

Option-2 requires the NG-RAN to recognize MBS session activity from the PDU session level messages and take actions. It relies on the PDU session level messages to transfer the MBS session state change information. It brings some complexity in NG-RAN.

Option-3 utilizes the multicast session deactivation procedure to allow NG-RAN to be able to release radio resources. It requires that MB-SMF should be aware of the involved NG-RANs, or the MB-SMF should be aware of the involved AMFs and the AMFs should be area of the involved NG-RANs.

[Proposal-2]: If the multicast session deactivation optimization is concluded to be sent from MB-SMF to AMF to NG-RAN, Option-3 is recommended. Otherwise, Option-1 is recommended.

### Proposal

It is proposed to update TS 23.247 v0.2.0 as follows based on Option-1 and Option-3:

7.2.2.X SMF Removing Joined UEs from MBS Session

When the SMF receives the multicast session release request from the MB-SMF, the SMF initiated PDU session modification to remove joined UEs from the MBS session.

[If Option-3 is adopted:
NOTE: The MB-SMF can trigger Multicast Session Deactivation towards the NG-RAN via the AMF to release radio resources of the MBS session as specified in clause 7.2.X, prior to or in parallel with sending multicast session release request to the SMF.]

### Figure 7.2.2.X-1: SMF Removing Joined UEs from MBS Session

1. The SMF receives Multicast Session Release request from the MB-SMF with MBS Session ID. The SMF checks joined UEs. The SMF sends Multicast Session Release response to the MB-SMF
2. For each joined UEs, the SMF sends N4 Session Modification Request to the UPF. The UPF release the user plane resources and sends the N4 Session Modification Response to the SMF.
3. For each joined UEs, the SMF invokes Namf_Communicate_N1N2MessageTransfer to the AMF. The N1 SM container indicates MBS session release. In N2 SM information, the SMF informs the NG-RAN to remove the UE from the MBS session.
4. The AMF sends N2 Request to the NG-RAN
5. The NG-RAN transports the N1 SM container (PDU Session Modification Command) to the UE.
6. The NG-RAN performs radio resource modification. If no joined UEs in the MBS session, the NG-RAN release the radio resources.

[If Option-3 is adopted:

NOTE: The radio resource may already have been released by the NG-RAN when the Multicast Session Deactivation Request is received.]
7. If no joined UEs in the MBS session, for unicast transport of N3mb, the NG-RAN initiates the DL tunnel release towards MB-UPF via AMF and MB-SMF. For multicast transportation of N3mb, the NG-RAN perform IGMP/MLD Leave for the MBS session.
8. The NG-RAN sends N2 Response to the AMF. If no joined UEs in the MBS session, the MBS Session context is removed from the NG-RAN.
9. The AMF transfers the N2 message received in step 8 to the SMF via the Nsmf_PDUSession_UpdateSMContext service operation. The SMF removes the UE from the MBS Session.

1.-41. (canceled)

42. A method implemented by a first network node of a communication system, the method comprising:
receiving a first multicast session release request from a second network node of the communication system, wherein the first multicast session release request includes an identifier of a multicast broadcast service (MBS) session;
selecting terminal devices having joined the MBS session from terminal devices served by the first network node; and
transmitting a first multicast session release response to the second network node.

43. The method of claim 42, further comprising transmitting an N4 session modification request to a user plane function for release of user plane resources.

44. The method of claim 42, further comprising transmitting a communication message to a third network node of the communication system, wherein the communication message includes the following:
an N1 session management container which indicates release of the MBS session, and
N2 session management information to inform a fourth network node of removal of a predetermined terminal device, of the selected terminal devices, from the MBS session, wherein the predetermined terminal device is associated with the fourth network node.

45. The method of claim 44, wherein the N2 session management information includes a session stop for the fourth network node to release radio resources of the MBS session.

46. The method of claim 44, wherein when the third network node is not aware of fourth network nodes involved in the MBS session, the method further comprises, in parallel with or prior to the transmission of the communication message:
transmitting a second multicast session deactivation or release request to the third network node, wherein the second multicast session deactivation or release request includes the identifier of the MBS session and a list of identifiers of the selected terminal devices; and
receiving a second multicast session deactivation or release response from the third network node.

47. The method of claim 42, wherein the first network node is a session management function and the second network node is a multicast broadcast session management function.

48. A method implemented by a second network node of a communication system that also includes one or more first network nodes, the method comprising:
transmitting a first multicast session release request including an identifier of a multicast broadcast service (MBS) session to each of the one or more first network nodes, which serve terminal devices having joined the MBS session; and
receiving a first multicast session release response from each of the one or more first network nodes.

49. The method of claim 48, wherein when the second network node is aware of fourth network nodes involved in the MBS session or when the second network node is aware of third network nodes involved in the MBS session which are aware of the involved fourth network nodes, the method further comprises, prior to the transmission of the first multicast session release request:
when the second network node decides to release the MBS session, transmitting a second multicast session deactivation or release request to a third network node, of the communication system, that is associated with the identifier of the MBS session; and
receiving a second multicast session deactivation or release response from the third network node.

50. The method of claim 48, wherein each of the one or more first network nodes is a session management function and the second network node is a multicast broadcast session management function.

51. A method implemented by a third network node of a communication system that also includes first and fourth network nodes, the method comprising:
receiving from the first network node a communication message that includes N2 session management information for informing the fourth network node of removal of a predetermined terminal device from a multicast broadcast service (MBS) session; and
transmitting the N2 session management information to the fourth network node.

52. The method of claim 51, wherein one or more of the following applies:
the communication message also includes an N1 session management container which indicates release of the MBS session; and
\the N2 session management information includes a session stop for the fourth network node to release radio resources of the MBS session.

53. The method of claim 51, wherein when a second network node of the communication system is aware of fourth network nodes involved in the MBS session or when the second network node is aware of third network nodes involved in the MBS session that are aware of the involved fourth network nodes, the method further comprises, prior to the reception of the communication message:
receiving from the second network node a first multicast session deactivation or release request including an identifier of the MBS session;
transmitting to the fourth network node a second multicast session deactivation or release request including the identifier of the MBS session;
receiving a second multicast session deactivation or release response from the fourth network node; and
transmitting a first multicast session deactivation or release response to the second network node.

54. The method of claim 51, wherein when the third network node is aware of fourth network nodes involved in the MBS session, the method further comprises, in parallel with or prior to the transmission of the N2 session management information:
transmitting to the fourth network node a third multicast session deactivation or release request including an identifier of the MBS session; and
receiving a third multicast session deactivation or release response from the fourth network node.

55. The method of claim 51, wherein when the third network node is not aware of fourth network nodes involved in the MBS session, the method further comprises, in parallel to or prior to the reception of the communication message:
receiving from the first network node a fourth multicast session deactivation or release request including an identifier of the MBS session and a list of identifiers of terminal devices having joined the MBS session and served by the first network node;
determining the involved fourth network nodes based on the list of identifiers of the terminal devices;
transmitting a fifth multicast session deactivation or release request to each of the involved fourth network nodes;
receiving a fifth multicast session deactivation or release response from a particular one of the involved fourth network nodes, to which the N2 session management information is transmitted; and
transmitting a fourth multicast session deactivation or release response to the first network node.

56. The method of claim 51, wherein the first network node is a session management function, the third network node is an access and mobility management function, and the fourth network node is a node of a next generation radio access network.

57. A method implemented by a fourth network node of a communication system that also includes a third network node, the method comprising:
receiving, from the third network node, a request including N2 session management information which indicates removal of a predetermined terminal device from a multicast broadcast service (MBS) session due to a session stop; and
transmitting a Protocol Data Unit session modification command to the predetermined terminal device indicating that the predetermined terminal device is to be removed.

58. The method of claim 57, further comprising releasing radio resources of the MBS session based on any of the following conditions:
when the predetermined terminal device is a last terminal device to be removed from the MBS session; and
based on the session stop when the predetermined terminal device is an initial terminal device to be removed from the MBS session.

59. The method of claim 57, wherein when a second network node of the communication system is aware of involved fourth network nodes or when the second network node is aware of involved third network nodes that are aware of involved fourth network nodes, the method further comprises, prior to the reception of the request:
receiving from the third network node a first multicast session deactivation or release request including the identifier of the MBS session;
releasing radio resources of the MBS session; and
transmitting a first multicast session deactivation or release response to the third network node.

60. The method of claim 57, wherein when the third network node is aware of involved fourth network nodes, the method further comprises, in parallel to or prior to the reception of the request:
receiving from the third network node a second multicast session deactivation or release request including an identifier of the MBS session;
releasing radio resources of the MBS session; and
transmitting a second multicast session deactivation or release response to the third network node.

61. The method of claim 57, wherein when the third network node is not aware of involved fourth network nodes, the method further comprises, in parallel to or prior to the reception of the request:
receiving from the third network node a third multicast session deactivation or release request that is based on a list of identifiers of the terminal devices from a second network node;
releasing radio resources of the MBS session; and
transmitting a third multicast session deactivation or release response to the third network node.

62. The method of claim 57, wherein the third network node is an access and mobility management function and the fourth network node is a node of a next generation radio access network.

63. A first network node, comprising:
a processor; and
a memory communicatively coupled to the processor and adapted to store instructions which, when executed by the processor, cause the first network node to perform the method of claim 42.

64. A second network node, comprising:
a processor; and
a memory communicatively coupled to the processor and adapted to store instructions which, when executed by the processor, cause the second network node to perform the method of claim 48.

65. A third network node, comprising:
a processor; and
a memory communicatively coupled to the processor and adapted to store instructions which, when executed by the processor, cause the third network node to perform the method of claim 51.

66. A fourth network node, comprising:
a processor; and
a memory communicatively coupled to the processor and adapted to store instructions which, when executed by the processor, cause the fourth network node to perform the method of claim 57.
